(19) United States
(12) Patent Application Publication
(10) Pub. No.: US 2026/0141777 A1
(43) Pub. Date: May 21, 2026

(54) NETWORKED REPLAY OF LIVE DRAW GAMES

(71) Applicant: Accel Entertainment, Burr Ridge, IL (US)

(72) Inventor: Mark Phelan, Chicago, IL (US)

(21) Appl. No.: 19/393,339

(22) Filed: Nov. 18, 2025

Related U.S. Application Data
(60) Provisional application No. 63/721,809, filed on Nov. 18, 2024.

(51) Int. Cl. G07F 17/32; G06F 7/58

(52) U.S. Cl. CPC G07F 17/323; G06F 7/588; G07F 17/329

(57) ABSTRACT

A computing system may include a repository of historical game draws, each of the historical game draws having been generated randomly and previously reported to users live at the time of generation and a game server configured to receive a request from a local computing system for a replay of a historical game draw, randomly select, in response to the request, a replay gameplay draw from the repository of historical gameplay draws, and transmit the selected replay gameplay draw to the local computing system to cause the local computing system to report the replay gameplay draw to one or more users.

### CROSS-REFERENCE TO RELATED APPLICATION

This application claims the benefit of priority to U.S. provisional application no. 63/721,809, filed on Nov. 18, 2024, which application is hereby incorporated by reference in its entirety.

### TECHNICAL FIELD

The instant disclosure generally relates to electronic draw-based games, including networked replay of such games.

### BACKGROUND

Many games, such as keno, bingo, etc. involve a draw of numbers or gameplay events that are then compared to user selections to determine winners. Draw-based games may be executed electronically. The draw for draw-based games is generally performed live.

### BRIEF DESCRIPTION OF THE DRAWINGS

FIG. 1 is a block diagram view of an example network draw game system.

FIG. 2 is a flow chart illustrating an example method of operating a network draw game system.

FIG. 3 is a flow chart illustrating an example method of performing a draw replay with a network draw game system.

FIG. 4 is a diagrammatic view of an example embodiment of a user computing environment.

### DETAILED DESCRIPTION

Known draw-based games are generally limited to live draws, performed either manually or electronically, due to the need to provide reliably random draws for fair gameplay. Fairness can also be ensured, however, by replaying previously live draws, provided that the draw to be replayed is itself selected at random from among many previous draws, and provided that a sufficiently large number of previous draws are available so that no single user can memorize the previous draws and make gameplay decisions based on known results.

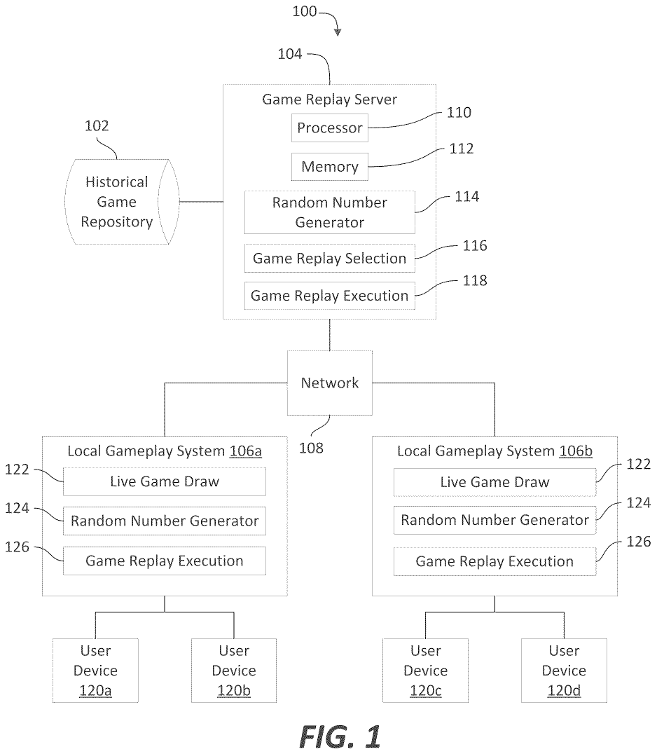

Referring to the drawings, wherein like numerals refer to the same or similar features in the various views, FIG. 1 is a diagrammatic view of an example network draw game system 100. The system 100 may include a historical game repository 102, a game replay server 104, and a plurality of local gameplay systems 106 (two such local gameplay systems 106a, 106b are shown) in communication with the game replay server 104 via a network 108. The network game system 100 may be deployed to generate and output a multi-player, network game.

The historical game repository 102 may be or may include a database or other data store that stores the results of a plurality of historical game draws for one or more games. The historical game draws may be stored such that the sequence and/or timing of the historical draw are preserved, in some embodiments. For example, a given entry in the repository 102 may include a sequence of numbers and a time lapse in between each number (e.g., a single time lapse used in between each number, or a specific respective time lapse for each number-to-number transition).

In some embodiments, an entry in the historical game repository 102 (e.g., a particular draw) may be stored in connection with the live draw information of the entry, such as a location, date, computing system or person that performed the live draw, and so on. Additionally or alternatively, an entry in the historical game repository 102 may be stored in connection with replay information respective of the entry, such as dates and times of replay, destination systems to which a replay was transmitted, and so on. Such information may assist with auditing the randomization quality and other fairness aspects of the system.

In some embodiments, the historical game repository 102 may store draws for a plurality of different games. For example, the historical game repository 102 may store a plurality of Keno draws, a plurality of Bingo draws, and/or a plurality of other lottery-type draws.

Although reference is made herein to “numbers” being drawn and/or reported for a game draw, it should be understood that numbers, letters, or other event designators that a player attempts to predict or match may be included in such a draw.

The game replay server 104 may be a computing system that is generally configured to add historical game draws to the repository 102, recall historical draws from the repository 102 for replay, and facilitate such replay in connection with the local gameplay systems 106. The game replay server 104 may be in communication with a plurality of local gameplay systems 106 that operate one or more (e.g., a plurality of) different games.

The game replay server 104 may include a processor 110 and a non-transitory, computer-readable memory 112 storing instructions that, when executed by the processor 110, cause the game replay server 104 to perform one or more of the methods, operations, functions, etc. of this disclosure.

The game replay server 104 may include one or more functional modules 114, 116, 118 that may be embodied in hardware and/or software. In some embodiments, the functional modules 114, 116, 118 may be embodied as instructions stored in the memory 112.

The random number generator 114 may be an algorithm or program that utilizes an environmental condition or other unpredictably variable value as the basis for generating one or more values that cannot be meaningfully predicted with better frequency than chance. The random number generator 114 may generate one or more random numbers within a predetermined range of values, such as the range of possible gameplay values for a particular game, or a range of values representative of a set of historical game draws.

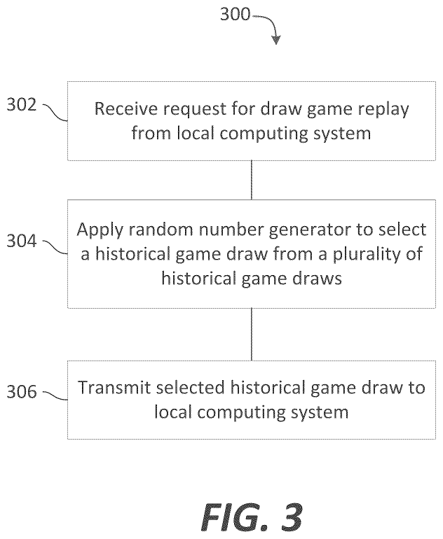

The game replay selection module 116 may be configured to receive a request for an historical game draw from a local gameplay system 106, select an historical game draw from the repository 102, and return the selected historical game draw to the requesting local gameplay system 106 in response to the request. Detail on the operation of the game replay selection module 116 will be described below with respect to FIG. 3. In some embodiments, the game replay selection module 116 may transmit the entirety of the historical draw to the local gameplay system 106 at one time, and the local gameplay system 106 may execute the draw. In other embodiments, the game replay server 104 may execute the draw, as described below with respect to the game replay execution module 118.

The game replay execution module 118 may be configured to execute an historical game draw, in embodiments in which execution is performed by the game replay server 104. For example, the game replay execution module 118 may receive an historical draw from the game replay selection module 116 and transmit the numbers in the historical draw in sequence to the requesting local computing system 106. Executing the game may include, for example, pausing for a predetermined quantity of time between the transmission of each number in the sequence. The predetermined quantity of time may have been included in the historical draw, or may be created by the game replay execution module 118.

In some embodiments, the game replay execution module 118 may perform the draw in the same order as its original, live version (e.g., the game replay execution module 118 may simply progress through the stored sequence of drawn numbers, in order). In other embodiments, the game replay execution module 118 may rearrange the order of the draw. For example, the game replay execution model 118 may use the random number generator 114 to select an index of the number to be drawn. For example, where the historical draw has twenty (20) numbers, the game replay execution module 118 may use the random number generator to determine a random number in the range 1-20 and may “draw” the number whose position in the historical draw sequence matches the random number. In other embodiments, the game replay execution module 118 may reverse the order of the draw or otherwise rearrange its order in a predetermined fashion. In yet other embodiments, replay of a previous game may include further randomization techniques as described below with respect to FIG. 3.

In some embodiments, the game replay selection module 116 and/or game replay execution module 118 may output a draw to a single local gameplay system 106. In some embodiments, the game replay selection module 116 and/or game replay execution module 118 may output a draw to a plurality of local gameplay systems 106 for simultaneous or overlapping replay on those local gameplay systems 106.

Each local gameplay system 106 may be configured to operate and output one or more games (e.g., one or more draw games) to one or more users. In some embodiments, a local gameplay system 106 may include a display. In some embodiments, a local gameplay system 106 may include one or more user input devices, such as a touchscreen, buttons, touchpad, etc. A local gameplay system 106 may be a computing system with an interface intended to be operated by a single user, and thus may be configured to output a game to a single user, in some embodiments. In other embodiments, a local gameplay system 106 may output to many users. For example, a local gameplay system 106 may be or may include a single-site server that hosts a game played on a plurality of user devices 120a, 120b, 120c, 120d, such as user terminals or user personal mobile devices that are registered with the local gameplay system 106.

Each local gameplay system 106 may be remote from the game replay server 104 and from each other local gameplay system 106, in some embodiments. Accordingly, each local gameplay system 106 may output a game to its own respective one or more users.

A local gameplay system 106 may include one or more functional modules 122, 124, 126 that may be embodied in hardware and/or software. In some embodiments, the functional modules 122, 124, 126 may be embodied as instructions stored in a memory of the local gameplay system 106, for execution by a processor of the local gameplay system 106.

The local gameplay system 106 may include a live game draw module 122 that executes a live draw for one or more games for live play by users. For example, the local gameplay system 106 may use a random number generator 124 to generate a random number, from among the available numbers for the game to be drawn, for each of a sequence of numbers. Further, the live game draw module 122 may perform the drawing of each number at a predetermined time interval following the previous number.

The local gameplay server 104 may store a generated live game draw created by the live game draw module 122. The local gameplay server 104 may transmit the stored live game draw, generated by the local gameplay system 106, to the game replay server 104 to be added to the repository of historical game draws 102. Such a transmission may be in response to a request from the game replay server 104. For example, in some embodiments, the game replay server 104 may periodically transmit a request for generated live game draws to each of the local gameplay systems 106. In response, a local gameplay system 106 may transmit, and the game replay server 104 may receive, one or more live game draw results that were performed in the time period since the last request by the game replay server 104. In some embodiments, the game replay server 104 may include such a request along with each transmission of an historical game draw. Alternatively, a request from a local gameplay system 106 to the game replay server 104 for an historical game draw may include one or more previously-unreported live game draws.

In response to receiving the one or more live draws, the game replay server 104 may add the received one or more live draws to the historical game repository 102.

The random number generator 124 on a local gameplay system 106 may be distinct from the random number generator 114 of the game replay server 104 and from the random number generator 124 of each other local gameplay system 106, in some embodiments. Alternatively, one or more local gameplay systems 106 and/or the game replay server 104 may access a centralized (e.g., network-accessible) random number generator service. In some embodiments, a given system may include multiple random number generators, each applying a unique randomization algorithm and/or using a unique seed value type.

Each local gameplay system 106 may also include a game replay execution module 126 that may be configured to execute an historical game draw, in embodiments in which execution is performed by the local gameplay system 106. Executing the game may include, for example, pausing for a predetermined quantity of time between the display or other output of each number in the sequence of the historical draw. The quantity of time may have been included in the historical draw, or may be created by the game replay execution module 126.

In some embodiments, the game replay execution module 126 may perform the draw in the same order as its original, live version (e.g., the game replay execution module 126 may simply progress through the stored sequence of drawn numbers, in order). In other embodiments, the game replay execution module 126 may rearrange the order of the draw. For example, the game replay execution module 126 may use the random number generator to select an index of the number to be drawn. That is, where the historical draw has twenty (20) numbers, the game replay execution module 126 may use the random number generator 124 to determine a random number in the range 1-20 and may “draw” the number whose position in the order matches the random number. In other embodiments, the game replay execution module 126 may reverse the order of the draw or otherwise rearrange its order in a predetermined fashion. In yet other embodiments, replay of a previous game may include further randomization techniques as described below with respect to FIG. 3.

For both live draw games and replayed draw games, a local gameplay system 106 may receive input from players in the form of gameplay input (e.g., number guesses, wagers, etc.) and may initiate the draw. When the draw is concluded (whether a live draw, a replayed draw executed by the local gaming system 106, or a replayed draw executed by the game replay server 104), the local gameplay system 106 may compare user gameplay input to the draw and determine and output the results of the game to the users. Such output may be on an output (e.g., display) of the local gameplay system 106 itself and/or on one or more user devices 120 in communication with the local gameplay system 106.

In one example mode of operation, a local gameplay system 106 may alternate between live draw games and historical draw replays. For example, the local gameplay system 106 may first conduct a game according to a live draw, as described above. After the live draw game is concluded, the local gameplay system 106 may then request an historical game draw from the game replay server 104. The local gameplay system 106 may then facilitate the game with the historical draw replay, either by executing the replay or outputting the draw replay as it is executed by the game replay server 106. The user experience—making guesses, entering wagers, viewing the draw and results, etc.—may be identical for the live draw and the historical draw replay, though the local gameplay system 106 may output an indicator as to whether a draw is live or a replay. After the replayed game is concluded, the local gameplay system 106 may either perform another live draw, or may request another historical game replay. In some embodiments, the local gameplay system 106 may perform a live draw at predetermined intervals, and may facilitate historical draw replay games in between those predetermined intervals.

In another example mode of operation, the game replay server 104 may coordinate simultaneous replay of an historical game draw on multiple local gameplay systems 106a, 106b. For example, a first local gameplay system 106a may request an historic draw replay. In response, the game replay server 104 may transmit a prompt to one or more other local gameplay systems, asking those local gameplay systems if they want to join the requested historic draw replay. A second local gameplay system 106b may automatically respond to the game replay server 104 with a request to join the historic draw replay. Alternatively, a second local gameplay system 106b may prompt the users playing on the second local gameplay system 106b to indicate if they want to join the requested historic draw replay. If at least one user responds and elects to join, the second local gameplay system 106b may respond to the game replay server 104 with a request to join the historic draw replay in response to the user election.

When the game replay server 104 coordinates simultaneous replay of an historical game draw on multiple local gameplay systems 106a, 106b, the game replay server 104 (e.g., the game replay execution module 118) may receive an historical draw from the game replay selection module 116 and simultaneously transmit the numbers in the historical draw in sequence to each requesting local gameplay system 106a, 106b, with the same intervals between numbers used as to all participating local gameplay systems 106a, 106b.

In some embodiments, where the game replay server 104 coordinates simultaneous replay of an historical game draw on multiple local gameplay systems 106a, 106b, each local gameplay system 106a, 106b may perform its own result determination and scoring, independent of the other participating local gameplay systems 106a, 106b. Alternatively, the game replay server 104 may transmit, to each participating local gameplay system 106a, 106b, identification information of each participating local gameplay system 106a, 106b, and the local gameplay systems 106a, 106b may communicate with one another for coordinated results and scoring. Additionally or alternatively, the participating local gameplay systems 106a, 106b may report their results to the game replay server 104, and the game replay server 104 may compile the individually-reported results, determine overall results, and report those overall results back to the participating local gameplay systems 106a, 106b.

In another example mode of operation, the game replay server 104 may cause different historical draws to be output on different local gameplay systems 106a, 106b, and those different historical draws may overlap with each other. For example, the game replay server 104 may receive a first request for an historical game draw replay from a first local computing system 106a, and may respond to that request as described herein. While the first historic draw is being executed, the game replay server 104 may receive a second request for an historical game draw replay from a second local computing system 106b, and may respond to that request as described herein, and independently of the response to the first request. Accordingly, the first and second draw replays may be overlapping in time in their execution. Many such overlapping replays may be executed in this manner.

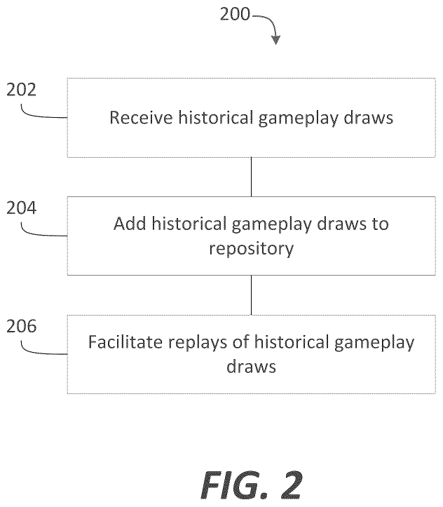

FIG. 2 is a flow chart illustrating an example method 200 of operating a network draw game system. The method 200, or one or more aspects of the method 200, may be performed by the game replay server 104. Accordingly, the method 200 may be computer-implemented or server-implemented.

The method 200 may include, at operation 202, receiving a plurality of historical gameplay draws. The historical gameplay draws may have been live draws at one or more (e.g., a plurality of) locations, and may have been performed by computing systems and/or manually. The historic gameplay draws may be received individually, or in batches. In some embodiments, the historic gameplay draws may be received and/or supplemented over time (e.g., as described above in connection with the local gameplay systems sending stored live draws to the game replay server). Each received historical gameplay draw may include an indexed sequence of numbers. An historical gameplay draw may also include, in some embodiments, information about the live draw recorded in the historical draw.

The method 200 may further include, at operation 204, adding the received historical draws to a repository of historical gameplay draws. Historic draws may be stored in connection with, for example, a unique index assigned to each historic draw. In some embodiments, historic draws may be stored in connection with usage information about each historic draw, such as a quantity of times an historic draw has been replayed, as well as the local gameplay system to which the draw was transmitted for each replay.

The method 206 may further include, at operation 206, facilitating one or more replays of the historic gameplay draws. Facilitating may include, for example, transmitting an entire historic draw at once for execution by a local gameplay system, executing the historic draw replay and transmitting each drawn number as it is drawn, causing multiple local gameplay systems to output the draw replay at the same time, and/or with other features disclosed herein.

FIG. 3 is a flow chart illustrating an example method 300 of performing a draw replay with a network draw game system. The method 300, or one or more aspects of the method 200, may be performed by the game replay server 104. Accordingly, the method 200 may be computer-implemented or server-implemented.

The method 300 may include, at operation 302, receiving a request for a draw game replay from a local computing system, such as a local gameplay system. The request received by the game replay selection module and transmitted by the local gameplay system may include, for example, an identification of a game, one or more parameters of the requested game (e.g., a quantity of numbers or other duration of game in the game requested, a quantity of players in the game requested, etc.), and/or other information that may be necessary to select a draw for the desired game.

The method 300 may further include, at operation 304, applying a random number generator to select a historical game draw from a plurality of historical game draws. For example, operation 304 may include generating a random number within a range of, or from a set of, indices of historical game draws. In some embodiments, operation 304 may include determining which historical game draws in a repository of historical game draws match the information included in the request received at operation 302 and ensuring that the generated random number selects a matching historical game draw. For example, operation 304 may include inputting the indices of the matching historical game draws to the random number generator as possible outputs. The historical game draw that is indicated by the generated random number may be retrieved from a data repository at operation 304.

The method 300 may further include, at operation 306, transmitting the selected historical game draw to the requesting local gameplay system in response to the request received at operation 302. For example, as discussed herein, the selected historical game draw may be transmitted to the requesting local gameplay station in a single transmission for the local gameplay system to execute the replay, or the replay may be executed by a game replay server and transmitted to the local gameplay system one drawn number at a time.

In some embodiments, the historical game draw may be executed in one of a number of different ways, examples of which are described below.

In a first example, replay execution method, the ball draws from the retrieved historical game may serve as selectors of particular random number generators that generate the played numbers in the game replay. For example, for the first number selected in the retrieved historical game, the first number may be used to select a first random number generator. That is, if ball 20 was the first draw in the historical game, then the first draw in the replay is Random(20). Similarly, if the second number selected in the retrieved historical game is 34, then the second draw in the replay is Random(34). In some embodiments, the selected random number generator may used a suitably unique value as a seed (e.g., clock value), such that Random(34) invoked in one game replay generates a different value than Random(34) in another game replay.

In another example, also based on multiple random number generators, a primary random number generator may be used to generate a large quantity of numbers. The historical game draws may be used to select respective random number generators as described above (e.g., ball 20 selects Random(20), ball 34 selects Random(34) and so on). The outputs of the generated random numbers may be summed, and the summed quantity of numbers may be “burned” (e.g., removed or skipped) from the large quantity of numbers generated by the primary random number generator, and the numbers following the “burned” set may be used as the replay game draw.

In another example, the historical draw order can be used as the input to a probabilistic mixing technique. For example, a “schema-perturbation” transition matrix or “Fisher-Yates” shuffle algorithm may be applied. The matrix will take a schema (supplied by the historical draw) then perturb (weighted table) an initial state to final state. The shuffle will take a finite list of elements (supplied by the historical draw) then rearrange (permutation swap) the list.

In a transition matrix approach, for each number in the historical draw, a random row/column pair is selected from the matrix. Transitions are typically weighted heavily to preserve original inputs.

In a shuffle algorithm approach, for each number in the historical draw, the number determines the next element in sequence. Position 20 swaps into position 1, position 34 swaps into position 2, etc.

A third approach is to periodically replenish an old data pool with a new data pool. In this way a finite source of data may be extended to be infinite. A randomly selected outcome that is hidden will be ‘random’ by definition until revealed. Thus, randomness and non-zero probability of any outcome may be preserved. Data pool replenishment may be centered around source and timing. The source could be internal (such as onboard software) or external (such as server signal) that maintains a steady reload of input information. The timing could be a count of data calls to reference a trigger threshold or a refresh window proportional to the data pool size. More specifically, for each number selected in a historical draw, a one-to-one mapping of the number drawn can be used. The refill system can be accessed based on the drawn number to achieve a continual stream of input data.

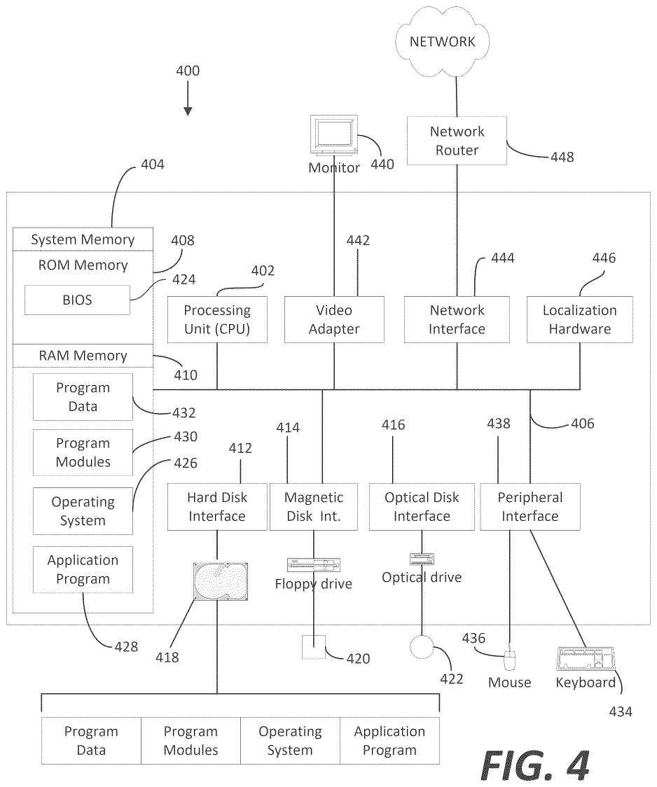

FIG. 4 is a diagrammatic view of an example embodiment of a user computing environment that includes a computing system environment 400, such as a desktop computer, laptop, smartphone, tablet, or any other such device having the ability to execute instructions, such as those stored within a non-transient, computer-readable medium. For example, the computing system environment 400 may be a user device 120, and components of the computing system environment 400 may comprise the local gameplay system 106. In another example, one or more components of the computing system environment 400, such as one or more CPUs 402, RAM memory 410, network interface 444, and one or more hard disks 418 or other storage devices, such as SSD or other FLASH storage, may be included in the game replay server 104. Furthermore, while described and illustrated in the context of a single computing system, those skilled in the art will also appreciate that the various tasks described hereinafter may be practiced in a distributed environment having multiple computing systems linked via a local or wide-area network in which the executable instructions may be associated with and/or executed by one or more of multiple computing systems.

In its most basic configuration, computing system environment 400 typically includes at least one processing unit 402 and at least one memory 404, which may be linked via a bus. Depending on the exact configuration and type of computing system environment, memory 404 may be volatile (such as RAM 410), non-volatile (such as ROM 408, flash memory, etc.) or some combination of the two. Computing system environment 400 may have additional features and/or functionality. For example, computing system environment 400 may also include additional storage (removable and/or non-removable) including, but not limited to, magnetic or optical disks, tape drives and/or flash drives. Such additional memory devices may be made accessible to the computing system environment 400 by means of, for example, a hard disk drive interface 412, a magnetic disk drive interface 414, and/or an optical disk drive interface 416. As will be understood, these devices, which would be linked to the system bus 406, respectively, allow for reading from and writing to a hard disk 418, reading from or writing to a removable magnetic disk 420, and/or for reading from or writing to a removable optical disk 422, such as a CD/DVD ROM or other optical media. The drive interfaces and their associated computer-readable media allow for the nonvolatile storage of computer readable instructions, data structures, program modules and other data for the computing system environment 400. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 400.

A number of program modules may be stored in one or more of the memory/media devices. For example, a basic input/output system (BIOS) 424, containing the basic routines that help to transfer information between elements within the computing system environment 400, such as during start-up, may be stored in ROM 408. Similarly, RAM 410, hard disk 418, and/or peripheral memory devices may be used to store computer executable instructions comprising an operating system 426, one or more applications programs 428 (which may include the functionality of the computing system 110 of FIG. 1 or one or more of its functional modules 114, 116, 118, 122, 124, 126 for example), other program modules 430, and/or program data 432. Still further, computer-executable instructions may be downloaded to the computing environment 400 as needed, for example, via a network connection.

An end-user may enter commands and information into the computing system environment 400 through input devices such as a keyboard 434 and/or a pointing device 436. While not illustrated, other input devices may include a microphone, a joystick, a game pad, a scanner, etc. These and other input devices would typically be connected to the processing unit 402 by means of a peripheral interface 438 which, in turn, would be coupled to bus. Input devices may be directly or indirectly connected to processor 402 via interfaces such as, for example, a parallel port, game port, firewire, or a universal serial bus (USB). To view information from the computing system environment 400, a monitor 440 or other type of display device may also be connected to bus via an interface, such as via video adapter 442. In addition to the monitor 440, the computing system environment 400 may also include other peripheral output devices, not shown, such as speakers and printers.

The computing system environment 400 may also utilize logical connections to one or more computing system environments. Communications between the computing system environment 400 and the remote computing system environment may be exchanged via a further processing device, such a network router 448, that is responsible for network routing. Communications with the network router 448 may be performed via a network interface component 444. Thus, within such a networked environment, e.g., the Internet, World Wide Web, LAN, or other like type of wired or wireless network, it will be appreciated that program modules depicted relative to the computing system environment 400, or portions thereof, may be stored in the memory storage device(s) of the computing system environment 400.

The computing system environment 400 may also include localization hardware 446 for determining a location of the computing system environment 400. In embodiments, the localization hardware 446 may include, for example only, a GPS antenna, an RFID chip or reader, a WiFi antenna, or other computing hardware that may be used to capture or transmit signals that may be used to determine the location of the computing system environment 400.

Networked game draw replay according to the present disclosure provides numerous benefits. First, for a proprietor of numerous gaming devices or locations, a backend server that provides game replays over a network can lessen the processing load of the local systems by reducing the frequency with which those systems must generate new draws. Further, by offering replays of previous games that have proven to have been legitimate random draws, a system according to the present disclosure can increase a quantity of games played while maintaining ensured randomness and quality. Still further, in systems in which live draws are limited to certain hours, frequencies, etc., mixing live draws with historic draw replays as described herein can offer an improved gameplay system and an improved experience for the player.

In a first aspect of the present disclosure, a system is provided that includes a first computing system configured to conduct a multi-player electronic game by applying a random number generator to generate a random gameplay draw and reporting the gameplay draw to each of a plurality of live users. The system further includes a backend computing system configured to receive the gameplay draw, store the gameplay draw in a repository of gameplay draws, receive a request for a draw replay, select, in response to the request, a gameplay draw from the repository of gameplay draws, and transmit the selected gameplay draw to a local computing system for replay to one or more users.

In an embodiment of the first aspect, the first computing system is the backend computing system.

In an embodiment of the first aspect, the gameplay draw is a keno draw.

In an embodiment of the first aspect, selecting the gameplay draw from the repository of gameplay draws includes applying a random number generator to select the gameplay draw randomly.

In an embodiment of the first aspect, transmitting the selected gameplay draw to a local computing system for replay to one or more users includes transmitting the selected gameplay draw to a plurality of local computing systems for replay to a respective one or more users associated with the plurality of local computing systems. In a further embodiment of the first aspect, transmitting the selected gameplay draw to a plurality of local computing systems for replay to a respective one or more users associated with the plurality of local computing systems includes transmitting the selected gameplay draw to a plurality of local computing systems for simultaneous replay to a respective one or more users associated with the plurality of local computing systems.

In an embodiment of the first aspect, the selected gameplay draw is executed on the local computing system.

In an embodiment of the first aspect, the selected gameplay draw is executed on the backend computing system.

In a second aspect of the present disclosure, a computing system is provided that includes a repository of historical game draws, each of the historical game draws having been generated randomly and previously reported to users live at the time of generation, and a game server configured to receive a request from a local computing system for a replay of a historical game draw, randomly select, in response to the request, a replay gameplay draw from the repository of historical gameplay draws, and transmit the selected replay gameplay draw to the local computing system to cause the local computing system to report the replay gameplay draw to one or more users.

In an embodiment of the second aspect, the repository stores a respective plurality of historical game draws for each of a plurality of games, the request includes an indication of a particular game, and randomly selecting the replay gameplay draw comprises selecting a gameplay draw from the historical gameplay draws for the particular game.

In an embodiment of the second aspect, transmitting the selected replay gameplay draw to the local computing system to cause the local computing system to report the replay gameplay draw to one or more users includes transmitting the selected replay gameplay draw to the local computing system to cause the local computing system to report the replay gameplay draw in a same order as the previous reporting at the time of generation of the replay gameplay draw.

In an embodiment of the second aspect, transmitting the selected replay gameplay draw to the local computing system to cause the local computing system to report the replay gameplay draw to one or more users comprises transmitting the selected replay gameplay draw to the local computing system to cause the local computing system to report the replay gameplay draw in a different order than the previous reporting at the time of generation of the replay gameplay draw.

In an embodiment of the second aspect, transmitting the selected replay gameplay draw to the local computing system to cause the local computing system to report the replay gameplay draw to one or more users includes transmitting the selected gameplay draw to a plurality of local computing systems for replay to a respective one or more users associated with the plurality of local computing systems. In a further embodiment of the second aspect, transmitting the selected gameplay draw to a plurality of local computing systems for replay to a respective one or more users associated with the plurality of local computing systems includes transmitting the selected gameplay draw to a plurality of local computing systems for simultaneous replay to a respective one or more users associated with the plurality of local computing systems.

In an embodiment of the second aspect, the selected historical gameplay draw is executed on the computing system.

In a third aspect of the present disclosure, a server-implemented method is provided that includes receiving a first request from a first local computing system for a replay of a historical game draw, randomly selecting, in response to the first request, a first replay gameplay draw from a repository of historical gameplay draws, transmitting the selected first replay gameplay draw to the first local computing system to cause the first local computing system to report the first replay gameplay draw to one or more users, receiving a second request from a second local computing system for a replay of a historical game draw, randomly selecting, in response to the second request, a second replay gameplay draw from the repository of historical gameplay draws, and transmitting the selected second replay gameplay draw to the second local computing system to cause the second local computing system to report the second replay gameplay draw to one or more users.

In an embodiment of the third aspect, transmitting the selected first replay gameplay draw to the first local computing system and transmitting the selected second replay gameplay draw to the second local computing system causes reporting of the first replay game draw to overlap in time with the reporting of the second replay game draw.

In an embodiment of the third aspect, transmitting the selected first replay gameplay draw to the first local computing system includes transmitting one gameplay event at a time from the first replay gameplay draw, and transmitting the selected second replay gameplay draw to the second local computing system includes transmitting one gameplay event at a time from the second replay gameplay draw, whereby the reporting of the first replay game draw overlaps in time with the reporting of the second replay game draw.

In an embodiment of the third aspect, the method further includes receiving, from a third local computing system, after transmitting the first and second gameplay replay draws, a live gameplay draw, and adding the live gameplay draw to the repository of historical gameplay draws.

In an embodiment of the third aspect, the repository stores a respective plurality of historical game draws for each of a plurality of games, the first request includes an indication of a first particular game, randomly selecting the first replay gameplay draw includes selecting a gameplay draw from the historical gameplay draws for the first particular game, the second request includes an indication of a second particular game that is different from the first particular game, and randomly selecting the second replay gameplay draw includes selecting a gameplay draw from the historical gameplay draws for the second particular game.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments. It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

What is claimed is:

1. A system comprising:
a first computing system configured to conduct a multi-player electronic game by:
applying a random number generator to generate a random gameplay draw; and
reporting the gameplay draw to each of a plurality of live users; and
a backend computing system configured to:
receive the gameplay draw;
store the gameplay draw in a repository of gameplay draws;
receive a request for a draw replay;
select, in response to the request, a gameplay draw from the repository of gameplay draws; and
transmit the selected gameplay draw to a local computing system for replay to one or more users.

2. The system of claim 1, wherein the first computing system is the backend computing system.

3. The system of claim 1, wherein the gameplay draw is a keno draw.

4. The system of claim 1, wherein selecting the gameplay draw from the repository of gameplay draws comprises applying a random number generator to select the gameplay draw randomly.

5. The system of claim 1, wherein transmitting the selected gameplay draw to a local computing system for replay to one or more users comprises transmitting the selected gameplay draw to a plurality of local computing systems for replay to a respective one or more users associated with the plurality of local computing systems.

6. The system of claim 5, wherein transmitting the selected gameplay draw to a plurality of local computing systems for replay to a respective one or more users associated with the plurality of local computing systems comprises transmitting the selected gameplay draw to a plurality of local computing systems for simultaneous replay to a respective one or more users associated with the plurality of local computing systems.

7. The system of claim 1, wherein the selected gameplay draw is executed on the local computing system.

8. The system of claim 1, wherein the selected gameplay draw is executed on the backend computing system.

9. A computing system comprising:
a repository of historical game draws, each of the historical game draws having been generated randomly and previously reported to users live at the time of generation; and
a game server configured to:
receive a request from a local computing system for a replay of a historical game draw;
randomly select, in response to the request, a replay gameplay draw from the repository of historical gameplay draws; and
transmit the selected replay gameplay draw to the local computing system to cause the local computing system to report the replay gameplay draw to one or more users.

10. The computing system of claim 9, wherein:
the repository stores a respective plurality of historical game draws for each of a plurality of games;
the request includes an indication of a particular game; and
randomly selecting the replay gameplay draw comprises selecting a gameplay draw from the historical gameplay draws for the particular game.

11. The computing system of claim 9, wherein transmitting the selected replay gameplay draw to the local computing system to cause the local computing system to report the replay gameplay draw to one or more users comprises transmitting the selected replay gameplay draw to the local computing system to cause the local computing system to report the replay gameplay draw in a same order as the previous reporting at the time of generation of the replay gameplay draw.

12. The computing system of claim 9, wherein transmitting the selected replay gameplay draw to the local computing system to cause the local computing system to report the replay gameplay draw to one or more users comprises transmitting the selected replay gameplay draw to the local computing system to cause the local computing system to report the replay gameplay draw in a different order than the previous reporting at the time of generation of the replay gameplay draw.

13. The computing system of claim 9, wherein transmitting the selected replay gameplay draw to the local computing system to cause the local computing system to report the replay gameplay draw to one or more users comprises transmitting the selected gameplay draw to a plurality of local computing systems for replay to a respective one or more users associated with the plurality of local computing systems.

14. The computing system of claim 13, wherein transmitting the selected gameplay draw to a plurality of local computing systems for replay to a respective one or more users associated with the plurality of local computing systems comprises transmitting the selected gameplay draw to a plurality of local computing systems for simultaneous replay to a respective one or more users associated with the plurality of local computing systems.

15. The computing system of claim 9, wherein the selected historical gameplay draw is executed on the computing system.

16. A server-implemented method comprising:
receiving a first request from a first local computing system for a replay of a historical game draw;
randomly selecting, in response to the first request, a first replay gameplay draw from a repository of historical gameplay draws;
transmitting the selected first replay gameplay draw to the first local computing system to cause the first local computing system to report the first replay gameplay draw to one or more users;
receiving a second request from a second local computing system for a replay of a historical game draw;
randomly selecting, in response to the second request, a second replay gameplay draw from the repository of historical gameplay draws; and
transmitting the selected second replay gameplay draw to the second local computing system to cause the second local computing system to report the second replay gameplay draw to one or more users.

17. The server-implemented method of claim 16, wherein:
transmitting the selected first replay gameplay draw to the first local computing system and transmitting the selected second replay gameplay draw to the second local computing system causes reporting of the first replay game draw to overlap in time with the reporting of the second replay game draw.

18. The server-implemented method of claim 16, wherein:
transmitting the selected first replay gameplay draw to the first local computing system comprises transmitting one gameplay event at a time from the first replay gameplay draw; and
transmitting the selected second replay gameplay draw to the second local computing system comprises transmitting one gameplay event at a time from the second replay gameplay draw;
whereby the reporting of the first replay game draw overlaps in time with the reporting of the second replay game draw.

19. The server-implemented method of claim 16, further comprising:
receiving, from a third local computing system, after transmitting the first and second gameplay replay draws, a live gameplay draw; and
adding the live gameplay draw to the repository of historical gameplay draws.

20. The server-implemented method of claim 16, wherein:
the repository stores a respective plurality of historical game draws for each of a plurality of games;
the first request includes an indication of a first particular game;
randomly selecting the first replay gameplay draw comprises selecting a gameplay draw from the historical gameplay draws for the first particular game;
the second request includes an indication of a second particular game that is different from the first particular game; and
randomly selecting the second replay gameplay draw comprises selecting a gameplay draw from the historical gameplay draws for the second particular game.
